(19) United States
(12) Patent Application Publication
(10) Pub. No.: US 2025/0234344 A1
(43) Pub. Date: Jul. 17, 2025

(54) METHOD AND SYSTEM FOR RADIO COMMUNICATION SCHEDULING

(71) Applicant: Rohde & Schwarz GmbH & Co. KG, Munich (DE)

(72) Inventors: Juan MOSONG, Munich (DE); Thomas NITSCHE, Munich (DE); Matteo SALMISTRARO, Munich (DE); Yadhunandana KUMARAIAH, Munich (DE)

(73) Assignee: Rohde & Schwarz GmbH & Co. KG, Munich (DE)

(21) Appl. No.: 18/414,912

(22) Filed: Jan. 17, 2024

(51) Int. Cl. H04W 72/12; G06F 3/0486

(52) U.S. Cl. CPC H04W 72/12; G06F 3/0486

(57) ABSTRACT

The present disclosure relates to a method for radio communication scheduling. The method comprises: providing a graphical user interface, GUI, which shows graphical representations of a time grid and a number of scheduling elements; receiving a user input on the GUI, wherein the user input defines scheduling information; and performing a radio communication scheduling based on the scheduling information.

### TECHNICAL FIELD

The disclosure relates to mobile radio communication scheduling, such as MAC scheduling in 4G or 5G networks.

### BACKGROUND ART

Medium access control (MAC) schedulers play a crucial role in managing access to a communication medium in networked environments to ensure efficient and collision-free data transmissions. For instance, a MAC scheduler assigns bandwidth resources to user equipment (UE) in the network environment and determines how uplink and downlink channels are used by the UEs.

As mobile radio communication technologies evolve, MAC scheduling becomes increasingly flexible and complex. For instance, the complexity of MAC schedulers is incrementally enhanced as new features are introduced in the relevant communication standards. When designing a MAC scheduler, a user has to consider an increasing number of technical specification rules and ASN.1 parameters. Therefore, designing or simplifying a specification compliant MAC scheduler is a challenging task which requires a substantial effort.

### SUMMARY

Thus, there is a need to provide an improved method and an improved system for radio communication scheduling, which avoids the above-mentioned disadvantages.

This is achieved by the embodiments provided in the enclosed independent claims. Advantageous implementations of the present disclosure are further defined in the dependent claims.

According to a first aspect, the disclosure relates to a method for radio communication scheduling, comprising: providing a graphical user interface, GUI, which shows graphical representations of a time grid and a number of scheduling elements; receiving a user input on the GUI, wherein the user input defines scheduling information; performing a radio communication scheduling based on the scheduling information.

This achieves the advantage that a radio communication scheduling can be realized in a simple and user-friendly manner. For instance, a user only interacts with the GUI and does not have to manually input ASN. 1 parameters or code. The resulting scheduling can be compliant to a relevant technical specification, even if the user, who interacts with the GUI, has only mid-to-low level familiarity with the various parameters and constraints of the specification.

The radio communication scheduling can comprise an assignment of bandwidth to a number of user equipment (UE) in a mobile communication network (e.g., a 4G, 5G or 6G cellular network) and/or a decision on how uplink and downlink channels are used by the UEs in a cell.

For example, the user can input general conditions for the scheduling via the GUI. Based on this input, a detailed and specification compliant scheduling can be carried out. In other words, the input in the GUI can be converted in detailed scheduling instructions and/or a scheduler (e.g., a MAC scheduler) can be generated or modified based on this input.

The GUI can be shown on a display, e.g. a touch display, of a computing device. The computing device can further execute the scheduler or can be communicatively connected to a further computing device which executes the scheduler.

For example, the scheduling elements can comprise: downlink control information (DCI); uplink control information (UCI); channels, such as PDSCH (physical downlink shared channel), PUSCH (physical uplink shared channel), PUCCH (physical uplink control channel), PDCCH (physical downlink control channel); and/or reference signals that the control information schedules, such as CSI-RS, SRS, PT-RS, RSRP, or DMRS. Each of the DCI and/or UCI, channels and reference signals can be assigned to uplink or downlink slots in the time grid, or to special flexible slots (for uplink and downlink). Hereby, CSI stands for “channel state information”.

In an implementation form of the first aspect, the radio communication scheduling is performed by a scheduler which is directly or indirectly controlled by an output of the GUI. The scheduler can be a MAC scheduler.

In an implementation form of the first aspect, the time grid comprises a plurality of time slots for at least one wireless communication cell. The cell can be associated with a node in the wireless network (e.g., gNodeB).

In an implementation form of the first aspect, a number, a type, a duration and/or a pattern of the time slots is determined based on the user input. For instance, the number, type and/or duration of the time slots depends on a cell pattern and/or a duplexing pattern.

In this way, the user can determine a scheduling pattern over the duplexing resources.

For instance, a first user input can be received on the GUI. This first user input can determine the number, type and/or duration of the time slots. The time grid shown in the GUI can then be generated or adapted based on the received first user input.

In an implementation form of the first aspect, the method further comprises: assigning at least some of the number of scheduling elements to respective time slots of the time grid based on the user input.

In an implementation form of the first aspect, a scheduling element is assigned to a respective time slot via a drag and drop gesture on the GUI. For instance, the scheduling element is thereby dragged on the location of the time slot. The drag and drop gesture can be a second user input.

Alternatively or additionally, selectable scheduling elements can be shown if a user selects (e.g., right clicks) a position (e.g., a time slot) on the time grid.

For instance, the time grid could also comprise time slots to which no scheduling element is assigned.

In an implementation form of the first aspect, after assigning a scheduling element to a time slot of the time grid, the number of scheduling elements which are selectable for assigning to a further time slot of the time grid is restricted.

For instance, the number of selectable scheduling elements for assigning to subsequent positions on the time grid (which represent later points in a scheduling sequence) is restricted.

In an implementation form of the first aspect, the restriction depends on a multiplexing pattern and/or on a ASN.1 parameter.

ASN.1 (Abstract Syntax Notation One) is an interface description language for defining data structures. The ASN.1 parameter can be a parameter of a scheduling element, e.g. a PDSCH-configuration of a PDSCH element.

In an implementation form of the first aspect, the method further comprises: checking the scheduling information received via the user input on a consistency and/or on a conformity with a technical specification. The specification can be a 3GPP specification. This consistency and/or conformity check can be carried out in a basic operating mode.

In an implementation form of the first aspect, the consistency and/or conformity checking is deactivated or limited if a determined operating mode is selected. For instance, the determined operating mode can be an expert mode which can be selected on the GUI.

In an implementation form of the first aspect, the radio communication scheduling is performed in accordance with a determined mobile broadband standard release version. The mobile broadband standard release version can be a 3GPP release version, such as release 18 of 3GPP (Rel-18).

In an implementation form of the first aspect, the method further comprises: outputting scheduling instructions for carrying out the radio communication scheduling in a human-readable format. The format can be a JSON format. The scheduling instructions can be generated based on the scheduling information received via the GUI.

In an implementation form of the first aspect, the method further comprises: modifying a parameter of at least one scheduling element of the number of scheduling elements based on a further user input on the GUI. For example, one, more or all of the number of scheduling elements can be associated with at least one modifiable parameter.

According to a second aspect, the disclosure relates to a system for radio communication scheduling, comprising: a graphical user interface, GUI, which shows graphical representations of a time grid and a number of scheduling elements; wherein the GUI is configured to receive a user input which defines scheduling information; and a scheduler configured to perform a radio communication scheduling based on the scheduling information.

In an implementation form of the second aspect, the scheduler is directly or indirectly controlled by an output of the GUI.

The scheduler can be a MAC scheduler.

The system according to the second aspect of the disclosure can be configured to carry out the method according to the first aspect of the disclosure.

### BRIEF DESCRIPTION OF THE DRAWINGS

The above-described aspects and implementation forms of the present disclosure will be explained in the following description of specific embodiments in relation to the enclosed drawings, in which:

FIG. 1 shows a method for radio communication scheduling according to an embodiment;

FIG. 2A shows a section of a GUI used for radio communication scheduling according to an embodiment;

FIG. 2B shows a section of a GUI used for radio communication scheduling according to an embodiment;

FIG. 3 shows a section of a GUI used for radio communication scheduling according to an embodiment; and

FIG. 4 shows a system for radio communication scheduling according to an embodiment.

### DETAILED DESCRIPTIONS OF EMBODIMENTS

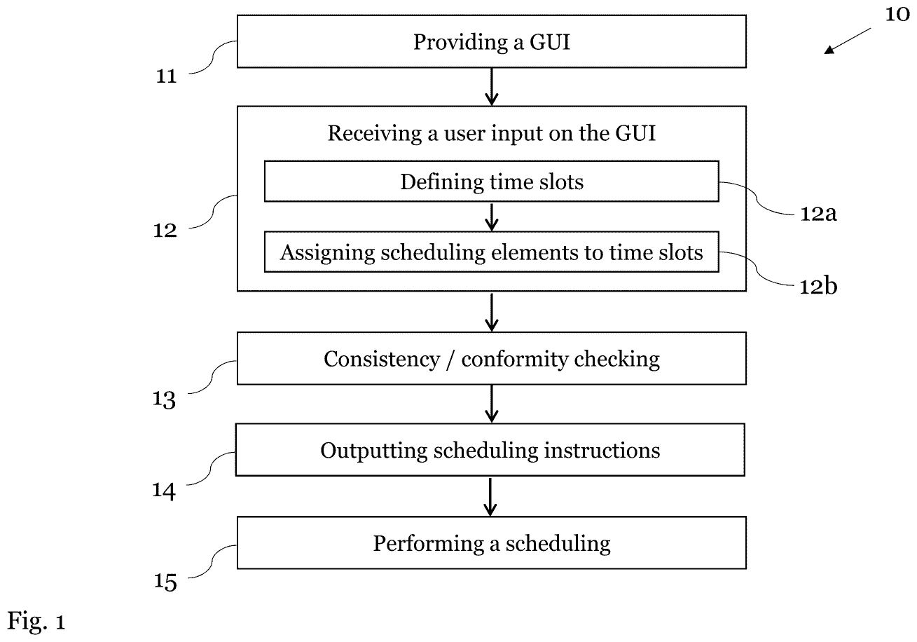

FIG. 1 shows a method 10 for radio communication scheduling according to an embodiment.

The method 10 comprises the steps of: providing 11 a GUI which shows graphical representations of a time grid and a number of scheduling elements; receiving 12 a user input on the GUI, wherein the user input defines scheduling information; and performing 15 a radio communication scheduling based on the scheduling information.

The step of performing 15 the radio communication scheduling can comprise an assignment of bandwidth to a number of user equipment (UE) in a mobile communication network (e.g., a 4G, 5G or 6G cellular network) and/or a decision on how uplink and downlink channels are used by the UEs in a cell.

This scheduling can be carried out by a MAC scheduler. The MAC scheduler can be directly or indirectly controlled by an output of the GUI.

The GUI can be a component of a graphical designer or design unit. The graphical designer can be operated by users with varying levels of expertise and knowledge of designing MAC schedulers. For instance, this interaction can comprise intuitive and easy to understand inputs, such as drawing and/or placing boxes, which represent time slots of the time grid and/or different scheduling elements in the grid. Thereby, the GUI provides a more intuitive alternative to a writing and inputting of computer readable code for generating scheduling parameters, which is a more difficult and error-prone process.

For instance, the time grid comprises a plurality of time slots for at least one cell of a wireless communication. The time slots can be represented by boxes in the GUI. The at least one cell can comprise a FDD (frequency division duplexing) and/or a TDD (time division duplexing) cell.

The number, type and/or duration of the time slots (i.e., the numerology of the cell) can be determined based on the user input and can be represented by a certain representation of the time slots (e.g., arrangement, size, colors etc.). For instance, the user input can comprise a first user input based on which the time slots of the time grid are defined (step 12a).

For example, for a specific cell (e.g., gNodeB), a user first defines a time profile (grid), which determines how the time is counted during scheduling. Each time slot in the time grid can be represented by a box. The user can define: (i) how many slots are needed for the scheduler. (e.g., the span of how many slots a scheduler covers and its periodicity, i.e., how often it repeats itself); (ii) a duration of the time slots (which can be determined by the length of the boxes), e.g. different numerologies can imply different slot durations; and (iii) a type of the slots: e.g., downlink (DL) slot, uplink (UL) slot, special flexible (FL) slot, or both (in case of FDD).

Each time slot box in the GUI can represent several parameters of the technology. For instance, the length of the box can represent the numerology, the quantity of slots can represent the span over which the scheduler applies (and makes up larger units of times, e.g. Frame, in the technology), and a color of a box can represent a type of slot (e.g., DL, UL, or FL).

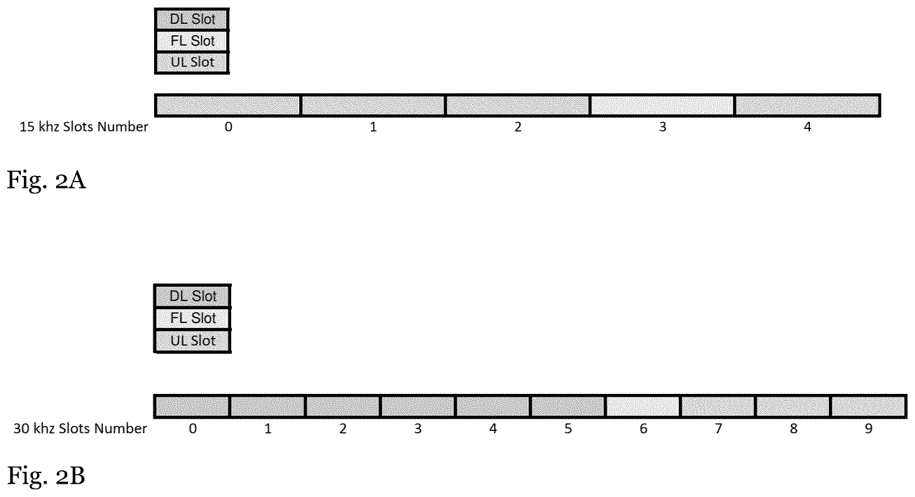

FIGS. 2A and 2B show different examples of time grids which can be displayed in the GUI. Thereby, FIG. 2A shows a time grid that comprises 15 kHz slots in a repeating pattern of 5 slots; wherein the coloring of the slots indicates a TDD direction. FIG. 2B shows a grid that comprises 30 kHz slots in a repeating pattern of 10 slots, wherein the coloring of the slots indicates a TDD direction. The time grids in FIGS. 2A and 2B comprise UL, DL and FL slots.

The method 10 can comprise the further step of: assigning 12b at least some of the number of scheduling elements to respective time slots of the time grid based on the user input.

For instance, the user can be offered a set of available scheduling elements which the user can arrange in different time slots of the time grid. This can be realized by: (a) displaying the set of available scheduling elements in a “scheduling element toolbox” (or other graphical representation) for dragging and dropping into a respective box (time slot) of the time grid; or (b) allowing a user to right click on a box of the time grid and displaying possible scheduling elements which can be placed in the box based on the type of slot represented by the box. For instance, in case of a DL slot, a downlink control information (DCI) but not an uplink control information (UCI) can be offered for scheduling.

The scheduling elements can comprise: (a) DL dynamically schedulable items, such as DCI0_1, DCI0_2, DCI1_0, DCI1_1, with corresponding scheduled shared channels like PDSCH, reference signals, etc.; (b) UL dynamically schedulable items, such as UCI (CSI, SR, HARQ) that can go on different channels, such as PUCCH, PUSCH; and/or (c) configured grants assignments, which can be scheduled, such as CG-PUSCH, SPS-PDSCH. Hereby, SPS stands for “semi persistent scheduling”.

Some of the shared channels which are scheduled can be repeated. For example, a scheduled PDSCH channel could be copied onto the next consecutive slot to represent a repetition when associated to the same scheduling element.

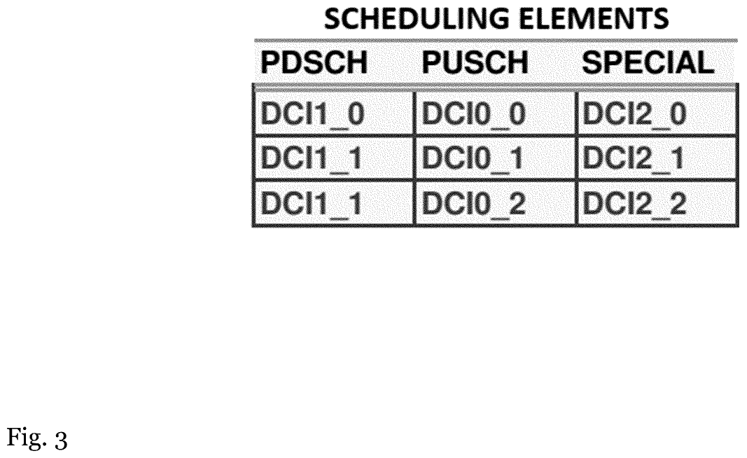

FIG. 3 shows an example of a graphical representation of scheduling elements in the form of a scheduling elements toolbox. This graphical representation can be displayed in the GUI.

For instance, the scheduling elements toolbox shows a selection of scheduling elements which the user can place by drag and drop into a time grid (as exemplarily shown in FIG. 2A an 2B). The scheduling elements shown in FIG. 3 only serve as an example and are not an exhaustive list of possible elements.

Some of the scheduling elements can be assigned automatically (i.e., without a specific user input) to certain time slots in the time grid. This automatic assignment can results from a previous assignment of another scheduling elements which corresponds to the same Harq process. For instance, if several scheduling elements belong to the same “scheduling chain”, only a few (or one) of the elements needs to be placed on the time grid by the user, and the remaining elements of the chain can be placed automatically. Furthermore, when placing each elements of a “scheduling chain” into a time slot, additional information about the parameters required for configuring the scheduler can be deducted from this arrangement.

Furthermore, when assigning 12b a scheduling element to a time slot, the number of available scheduling elements for subsequent assignments to further time slots can be restricted. For instance, time slots which are not “allowed” to be scheduled subsequently (e.g., due to restrictions or requirements of the technical specification) can be grayed out or otherwise marked as unavailable in the graphical representation of the scheduling elements (e.g., in the scheduling elements toolbox).

This restriction can depend on a multiplexing pattern of the time grid and/or on a ASN.1 parameter of the previously assigned scheduling element.

In a further example, the GUI can be configured to show connecting lines between scheduling elements in the time grid to imply a relation of the scheduling elements (i.e., to highlight that the elements belong to the same scheduling chain).

The information on the time grid, which is input in step 12a, and the assignment of scheduling elements to the grid, according to step 12b, can represent scheduling information on the basis of which a MAC scheduling can be carried out in step 15.

Furthermore, the method 10 and/or a scheduling designer which implements the method 10 may offer the capability to either block or allow a non TS (technical specification) compliant scheduling based on the user input.

For instance, different modes (e.g., an expert and a basic modes) can be provided. For instance, in the expert mode, no consistency or compliance checks are performed on the scheduling information which is received via the GUI, and specification non-compliance is allowed (e.g., for negative testing).

In contrast, in the basic mode, a consistency and/or conformity checking can be carried out (see step 13 in FIG. 1). As a consequence of such checking, invalid and technical specification non-compliance scheduling based on the received scheduling information can be prohibited and blocked automatically. This ensures that users without expert knowledge can perform TS compliant scheduling. This functionality can be deactivated or limited in the expert mode.

The scheduling can be performed 15 based on a technical specification release version or generation, e.g. based on a 3GPP release version (such as release 18 of 3GPP). In general, many technical specifications are progressively worked on and released, wherein each version can contain new features or extensions of previously available features. The effect of these new features or extension on the scheduler can thus be taken into account when performing the scheduling.

The scheduled elements can be provided with default parameter values. These parameters values could be modified by the user via a further user input on the GUI. The selection of parameters which the user can edit, can depend on the type of scheduling element that was selected. For editing an element, the user could right-click the desired scheduling element on the GUI (e.g., after assigning it to a time slot). Then, the applicable parameters for that scheduling element can become editable for the user.

For instance, if the scheduling element is a DCI, its aggregation level could be editable, while for a PDSCH element a modulation scheme or frequency resources could be editable.

Based on the user input, the GUI can output 14 a JSON file (or a file in a similar human-readable format). JSON stands for “Javascript Object Notation”. In the JSON file, the parameters required for a designed scheduler can be formatted in a schema. For instance, this file can be input into a software that configures and schedules the UEs in a wireless network based on the instructions in the file.

Alternatively or additionally, the GUI can directly generate runtime configuration messages based on the scheduling information and forward this configuration to a MAC scheduler (or generate a MAC scheduler based on the configuration).

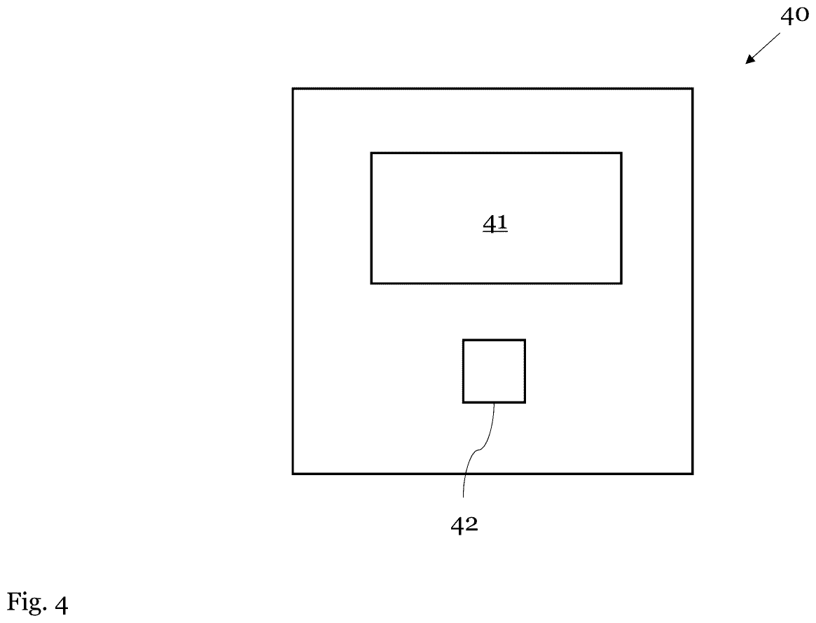

FIG. 4 shows a system 40 for radio communication scheduling according to an embodiment. The system 40 can execute the method 10 as shown in FIG. 1.

The system 40 comprises: the GUI 41 which shows graphical representations of the time grid and the number of scheduling elements; wherein the GUI 41 is configured to receive the user input which defines scheduling information. The system 40 further comprises a scheduler 42 which is configured to perform a radio communication scheduling based on the scheduling information.

For instance, the system 40 can comprise a computing device. The computing device can comprise a display for displaying the GUI. The computing device can further execute the scheduler 42. Alternatively, the computing device can be communicatively connected to a further computing device which executes the scheduler 42.

The scheduler 42 can be a MAC scheduler. The scheduler 42 can be directly or indirectly controlled by an output of the GUI 41.

In addition or alternatively, a file (e.g., a JSON file) which stores scheduling instructions can be generated based on an output of the GUI 41.

The system 40 can be operated in the expert mode or the basic mode as defined above.

All features described above or features shown in the figures can be combined with each other in any advantageous manner within the scope of the disclosure.

1. A method for radio communication scheduling, comprising:
providing a graphical user interface, GUI, which shows graphical representations of a time grid and a number of scheduling elements;
receiving a user input on the GUI, wherein the user input defines scheduling information; and
performing a radio communication scheduling based on the scheduling information.

2. The method of claim 1,
wherein the radio communication scheduling is performed by a scheduler which is directly or indirectly controlled by an output of the GUI.

3. The method of claim 1:
wherein the time grid comprises a plurality of time slots for at least one wireless communication cell.

4. The method of claim 3,
wherein a number, a type, a duration and/or a pattern of the time slots is determined based on the user input.

5. The method of claim 3, further comprising:
assigning at least some of the number of scheduling elements to respective time slots of the time grid based on the user input.

6. The method of claim 5,
wherein a scheduling element is assigned to a respective time slot via a drag and drop gesture on the GUI.

7. The method of claim 5,
wherein, after assigning a scheduling element to a time slot of the time grid, the number of scheduling elements which are selectable for assigning to a further time slot of the time grid is restricted.

8. The method of claim 7,
wherein the restriction depends on a multiplexing pattern and/or on a ASN.1 parameter.

9. The method of claim 1, further comprising:
checking the scheduling information received via the user input on a consistency and/or on a conformity with a technical specification.

10. The method of claim 9,
wherein the consistency and/or conformity checking is deactivated or limited if a determined operating mode is selected.

11. The method of claim 1,
wherein the radio communication scheduling is performed in accordance with a determined mobile broadband standard release version.

12. The method of claim 1, further comprising:
outputting scheduling instructions for carrying out the radio communication scheduling in a human-readable format.

13. The method of claim 1, further comprising:
modifying a parameter of at least one scheduling element of the number of scheduling elements based on a further user input on the GUI.

14. A system for radio communication scheduling, comprising:
a graphical user interface, GUI, which shows graphical representations of a time grid and a number of scheduling elements;
wherein the GUI is configured to receive a user input which defines scheduling information; and
a scheduler configured to perform a radio communication scheduling based on the scheduling information.

15. The system of claim 14,
wherein the scheduler is directly or indirectly controlled by an output of the GUI.
